(19) United States
(12) Patent Application Publication
(10) Pub. No.: US 2008/0091819 A1
(43) Pub. Date: Apr. 17, 2008

(54) Ethernet Ping Watchdog

(76) Inventor: Chongguan Yang, (US)

Correspondence Address: chongguan yang, 379 East 600 South #5, Salt Lake City, UT, 84111, US

(21) Appl. No.: 11/548,695

(22) Filed: Oct. 11, 2006

(51) Int. Cl. G06F 15/173

(52) U.S. Cl. 709/224

(57) ABSTRACT

A client computer system and a method of using Ping as a watchdog to reset a device. The computer system includes a printed circuit board, a software ping watchdog, and logic configured to drive the relay to change the power input to the controlled device. The printed circuit board includes a micro controller, a network controller and a relay.

### BACKGROUND OF THE INVENTION

1. Field of the Invention

This invention relates generally to networked computing systems, and, more particularly, to a system and method for restarting locked up device using a ping watchdog, such as for a DSL Modem or Cable Modem.

2. Description of the Related Art

FIG. 1 illustrates an exemplary network computing system. The network computing system includes a PC, a Linux Server, a network switch and a DSL Modem. Typically, the DSL Modem connects to the Internet through an ISP such as Qwest. However, DSL Modem tends to lock up or disconnect periodically. Therefore the Internet connection is lost or very poor. Several reasons may cause a modem to appear to lock up or frequently disconnect.
1. Power spikes—Faulty power strips can cause inconsistent power resulting in frequent disconnects and modem restarts.
2. Port scanning—Network monitoring programs that perform port scanning can cause the modem to lock up.
3. Viruses or worms—A virus or worm on your computer or network can cause the modem to lock up or frequently restart.

To get the modem back on line, Qwest gives these steps:
1. Unplug the black power cord from the back of the modem.
2. Wait 15 seconds and then plug it back in.
3. The Internet light on the front of the modem will be blinking as it initializes, and then becomes a steady light. This could take several minutes.
4. Wait for the steady light. Then try to access the Internet.

And same situation happen to Cable Modem. Both connection lost detection and modem reset needs human intervention. Other network server computer systems may experience same lock up problem and require reboot after lock up. It would be desirable to detect lock up and reset the device automatically.

### SUMMARY OF THE INVENTION

In one aspect of the present invention, a printed circuit board is disclosed. The printed circuit board includes a micro controller, a network controller and a relay. The micro controller and the network controller runs the software ping watchdog. The relay is configured to receive signals from the micro controller upon preset conditions to switch on and off the target device's power line. In another aspect of the present invention, a computer system is disclosed. The computer system includes the printed circuit board mentioned above and a software system. The software system includes an IP stack, a watchdog ICMP ping client and logic configured to reset a target device. The watchdog ping client is further configured to provide an indication in response to lost of connection to one or more computer server systems, with calculation of the ping loss rate to determine if the connection to servers is available. The logic is configured to drive the relay to reset the target device properly and restart the watchdog ping client after the connection is restored. In yet another aspect of the present invention, a method of deploy this computer system is disclosed. The computer system's network interface should be connected to a LAN switch with a non-blocked route to the computer server system it watches; the relay should be connected to the target device's power line. In still another aspect of the present invention, an actual prototype implementation is disclosed. The prototype implementation comprising: detailed print circuit board schematic, source code for the ping watchdog and source code for the relay driving logic.

### BRIEF DESCRIPTION OF THE DRAWINGS

The invention may be understood by reference to the following description taken in conjunction with the accompanying drawings, in which like reference numerals identify similar elements, and in which:

FIG. 1 illustrates a block diagram of a prior art network computer systems.

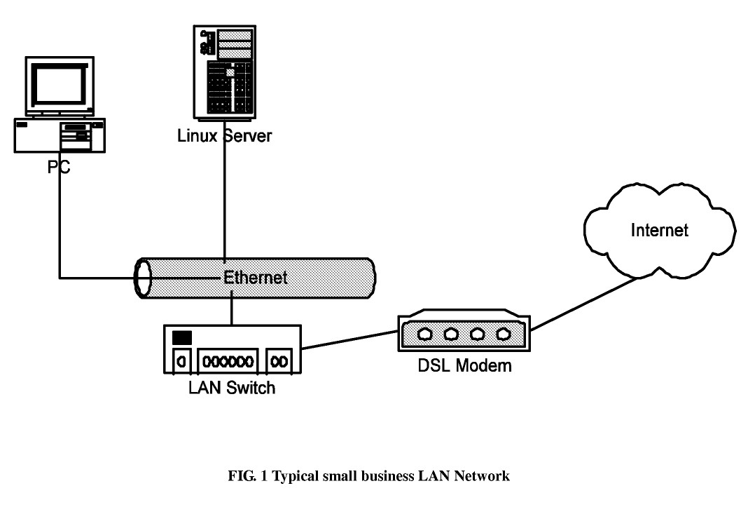

FIG. 2 illustrates block diagrams of embodiments of a computer system having a micro controller, a network controller and a relay, according to various aspects of the present invention. It also comprises a software ping watchdog, software IP stack, and software relay controlling logic.

FIG. 3 illustrates a flowchart of embodiments of the software ping client watchdog, and the relay controlling logic, according to various aspects of the present invention;

FIG. 4 illustrates a block diagram of an embodiment of the deployment of the present invention in a typical computer network system with DSL modem.

FIG. 5 illustrates a block diagram of an embodiment of the deployment of the present invention in a computer network system controlling a target Linux server.

FIG. 6 illustrates a block diagram of an embodiment of the present invention controlling a DSL Modem and a Linux file server computer.

FIG. 7 illustrates a schematic of a implementation prototype PCB board using Microchip PIC18452 micro controller, Ethernet controller ENC28J60 and Radio Shack 5VDC Relay 275-240.

### DETAILED DESCRIPTION OF SPECIFIC EMBODIMENTS

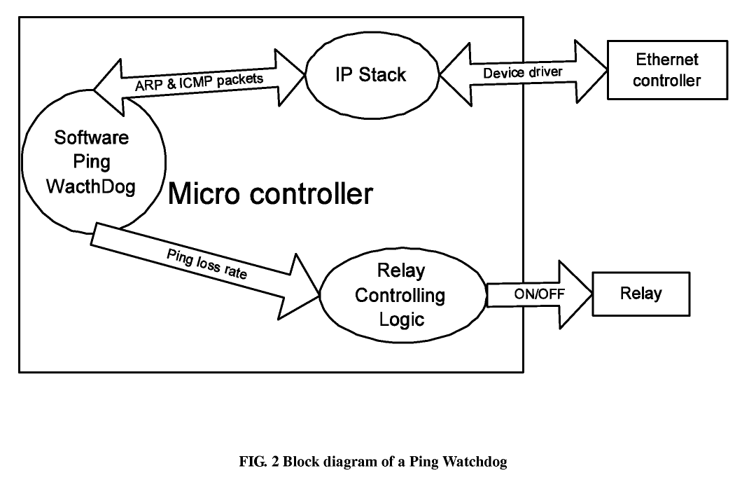

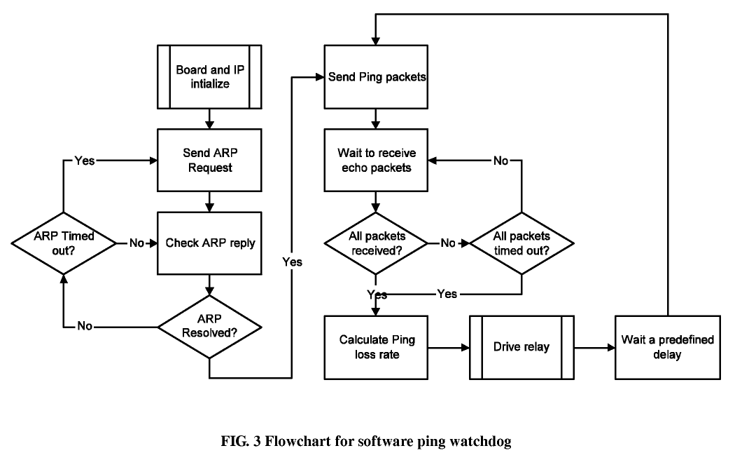

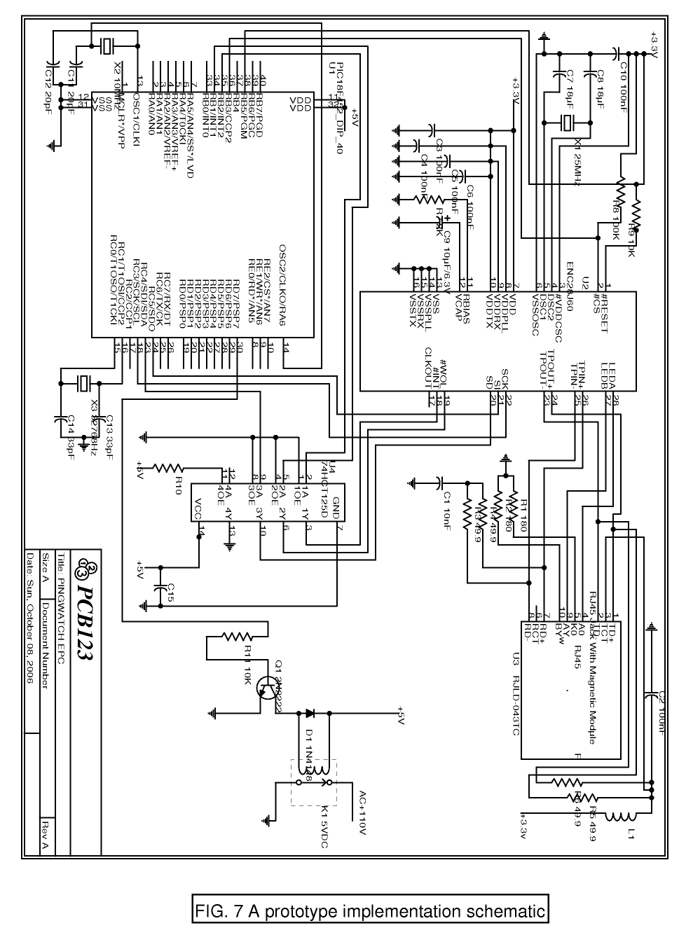

Illustrative embodiments of the invention are described below. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. The use of a letter in association with a reference number is intended to examples of the item to which the reference number is connected. Turning now to FIG. 2, block diagrams of embodiments of a computer system having a micro controller, a Ethernet controller and a relay are shown as well as the software combine them together. According to various aspects of the present invention, more relays may be added to control multiple devices. The micro controller provides a platform to run an embedded IP stack and the driver of the network controller. The network controller provides the physical interface to an Ethernet LAN. One of the digital outputs of the micro controller is connected to the relay's coil input. Auxiliary parts are omitted in the interest of clarity. In an actually implementation, digital output of the micro controller will control an NPN-transistor switch instead of control the relay directly to avoid excessive current to the micro controller. Also, a 10/100 BASE-T RJ45 Jack Tab-UP With Magnetic Module is needed to connect to the network controller to provide a female connector to standard Ethernet cable. In FIG. 7, actual prototype implementation schematic is shown using PIC18F452 micro controller, ENC28J60 Ethernet controller, and 5VDC Relay 275-240. FIG. 3 shows a flowchart of embodiments of the software ping watchdog, and the relay controlling logic. A ping watchdog is a piece of software that continuously sending a predefined amount of ICMP ECHO REQUEST packet to a predefined IP address, for a predefine time interval, with each ECHO REQUEST packet has a predefined time to live. It expects a predefine ICMP echo server running at that IP address will send back ICMP ECHO REPLY packet for each ICMP ECHO REQUEST packet the server received. It then waits until all ICMP ECHO REPLY packets are received or time out. Loss of ECHO REPLY indicates either the connection to the server is poor if the server is known to be alive; or the server is having trouble if the connection is known to be good. The software will wait a predefined delay, and the whole sequence of actions is repeated again. Each time a ping loss rate is calculated to pass to the relay controlling logic. In order to send a ICMP ECHO REQUEST to a computer server with only it's IP address is know, the ping watchdog must send a ARP REQUEST to resolve the server's MAC address. A software stack called IP-stack achieves the actual sending and receiving of ICMP packets and ARP packets. Many micro controller maker, software companies and open source software communities implement IP-stack or TCP-IP stack. However, it may needs some customization before it can be used in a certain actual implementation. In the presented prototype, a modified Microchip IP-stack is used. The ping.h and ping.c files implemented the software ping watchdog. The relay controlling logic includes turn off the relay when the ping loss rate passed from the ping watchdog is lower than a predefined threshold, wait a predefined delay, turn on the relay, wait another predefined delay and then restart the ping watchdog. In the presented prototype implementation, the drive_modem function implements this logic.

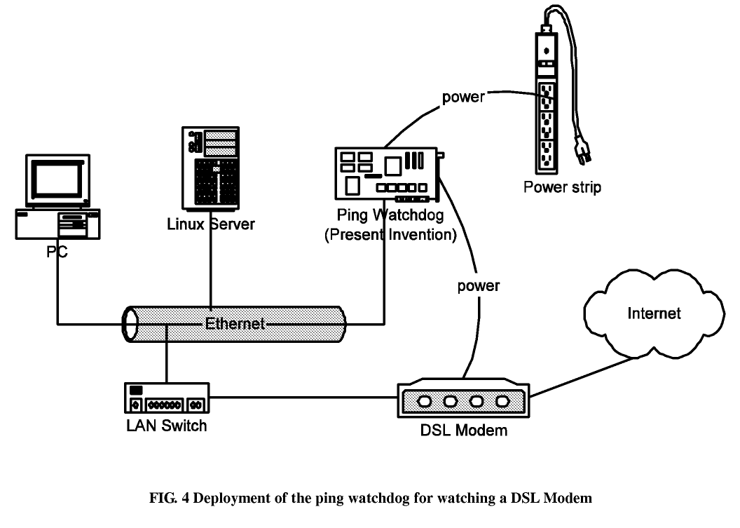

FIG. 4 shows a block diagram of an embodiment of the deployment of the present invention in a typical computer network system with DSL modem. In this deployment, the present invention is connected to a LAN switch, with the DSL modem connected to the upstream of this switch. A computer server IP address 66.102.7.99, which is www.google.com, is used as the ICMP server IP address for the ping watchdog. No firewall setting is in placing to block ICMP packets, so a non-blocked route to the ICMP server is in place. The power input of the DSL Modem is connected to the relay's output. Assume Google will keep their Internet server running all the time; the ping watchdog uses the ping loss rate to server 66.102.7.99 as its indication of the status of Internet connection, which further indicates the status of the DSL Modem. If the DSL Modem is locked up, the ping loss rate to server 66.102.7.99 with greater than a threshold value, said 70 percent, which power off the DSL Modem. The first delay in the relay driving logic is set to be 30 seconds, more than enough time for the recommended time for the DSL Modem unlock itself. Then the logic turns on the relay. The power to the DSL Modem is resumed. The second delay in the relay driving logic is set to be two and half minutes, which is enough time for the DSL Modem to be back on line. Then it restarts the ping watchdog. Be aware the Internet connection is resumed when the DSL Modem is back on line, which is before the restarting of the ping watchdog. With a total of less than three minutes, the Internet connection for this network is resumed automatically using the present invention.

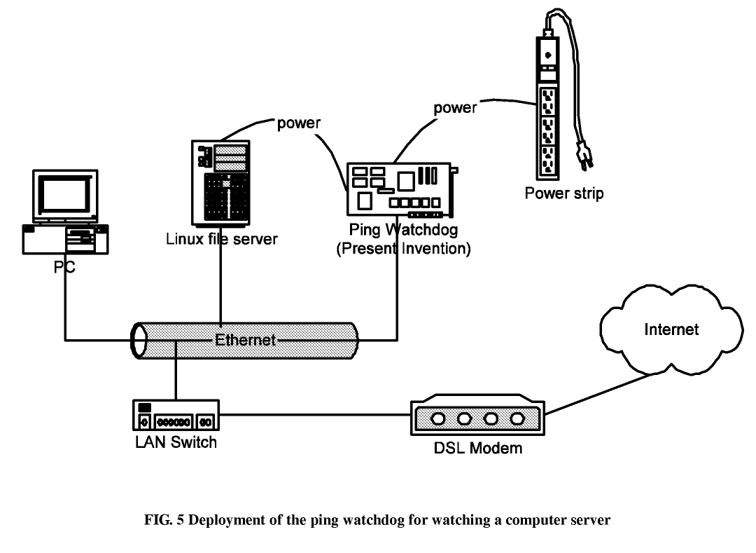

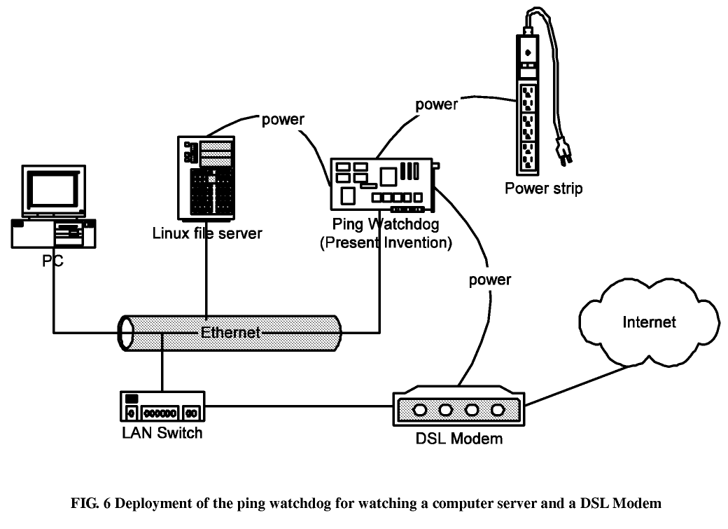

FIG. 5 shows a block diagram of an embodiment of the deployment of the present invention in a typical computer network system controlling a target computer server. In this deployment, the present invention is connected to an Ethernet LAN, with an intranet file server connected to the same LAN. The present invention's IP address is set to 192.168.0.200, while the intranet file server's IP address set to 192.168.0.201. No firewall is between the two computer systems and physical connection of Ethernet LAN is good. In additional, the ICMP server on the target computer server is running, which is by default for most operating systems. So a non-blocked route to the ICMP server is in place. The power input of the target computer server connected to the relay's output. Assume LAN connection is good all the time; the ping watchdog uses the ping loss rate to server 192.168.0.201 as its indication of its status. If the target computer server is locked up due to some unexpected events, the ping loss rate to server 192.168.0.201 will greater than a threshold value, said 99 percent, which will power off the file server. Then the logic turns on the relay. The power to the target computer server is resumed. The second delay in the relay driving logic is can be configure to fit the actually boot time of the file server. Then it restarts the ping watchdog. Thus the target computer server is rebooted automatically using the present invention, minimizing the service down time. This feature is desirable to network servers. The ping watch dog can be further configured to ping multiple server addresses instead of just one. It could ping 209.131.36.158, which is www.yahoo.com; 66.102.7.99, which is www.google.com; and 69.48.228.103, which is www.comcast.com. And for each ICMP server address, a ping loss rate is calculated individually. The ping watchdog won't act on relay until the ping loss rates for all three servers are greater than a preset threshold. This reduces the possibility of false device reset due to an Internet server's shut down. The print circuit board can comprise more than one relay, with each relay associated with at least one ICMP server IP address for the ping watchdog, and an individual configured logic to drive the relay. Combining FIG. 4 and FIG. 6, FIG. 6 shows the present invention drive two relays, one for the DSL Modem and one for intranet File server. The IP server address associated with the relay controlling the DSL modem is 66.102.7.99 and 69.48.228.103; the IP server address associate with the relay controlling the intranet file server is 192.168.0.201. Three ping loss rates are calculated, ping loss rate 1 for IP 66.102.7.99, ping loss rate 2 for 69.48.228.103, and ping loss rate 3 for 192.168.0.201. The logic configured for the relay controlling the DSL modem will only turn off the when both ping loss rate 1 and ping loss rate 2 are greater than 30; while the logic configured for the relay controlling won't turn off the relay until the ping loss rate 3 is 100. The ping to 66.102.7.99 and 69.48.228.103 will be resumed two and half minutes after the relay is restarted while the ping to 192.168.0.201 won't started until half an hour later, because file servers usually takes long time to boot up. The device can comprise a simple logging logic to log the relays action time. It can be implemented as simple table data structure to be kept in RAM, or written into FLASH memory. The formats for on record of log will the as following: first byte is relay ID, byte 2-9 is the time of relay action. The relay driving logic could be further configured to use this record to improve the device's fault tolerance. Say only a certain amount of relay action is allowed in a predefined time period. Otherwise, the relay driving logic will ignore the ping loss rate and relay is always on, which is effectively turned the ping watchdog for that particular relay. The print circuit board can comprise LEDs to show the status of each relay, as well as if the relay is under the ping watchdog's watch.

FIG. 7 is the detailed schematic of a prototype implementation. The major parts used in the schematic include: one Microchip PIC18F452 micro controller, one Microchip ENC28J60 Ethernet controller, one Philips 74HC125D quad buffer, one RJ45 female jack with magnetic module RJLD-043TC and one 5v DC Relay. The board is configured with only one relay. Appendix B shows the source code of the software ping watchdog implementation for this prototype. It only pings to one predefined IP address 66.102.7.99, which is www.yahoo.com. The first delay in the software relay controlling logic is 30 seconds. The second delay is two and half minutes. The prototype implementation can be use to watch Internet connection and control a DSL modem. Only the ping watchdog's source code and the relay driving logic's source code are listed to illustrate the ping watchdog method. The source code for the modified Microchip's IP Stack, utility functions and the Main function are not listed. An actual prototype board is built using Olimex prototype board for the interest of quick prototyping. The Olimex prototype board's micro controller and Ethernet part of schematic is similar to the schematic shown in FIG. 7. But the board has other unrelated components for the purpose of prototyping other applications. The Olimex board doesn't have any relay and relay driving part. So a secondary PCB prototype board is used to host R11, Q1, D1 and K1 part of the FIG. 7 schematic. The source code of software used in the actual prototype is the exact source code in Appendix B. The prototype is installed and worked well under testing conditions. The parts to build the board is listed below:

1 Olimex PIC-web prototyping board (containing PIC18F452 micro controller and EN28J60 Ethernet controller)

1 Radio shack 5VDC SPDT Relay 275-240

1 Radio shack small prototyping board

1 Radioshack NPN transistor 2N2222

1 Radio shack Diode 1N4148

1 Radio shack 10 k Resistor

1 Power adapter, outputting 9V 200 mA

Connecting wires

What is claimed is:

1. An computer system, comprising: a printed circuit board includes a micro controller, a network controller, a relay, and logic configured to drive the relay, wherein the micro controller runs a software ping watchdog to provide an indication to network connection status to one or more computer servers; wherein the network controller connects to the network that have an non blocked route to the computer servers; wherein the relay connects to the power line of a device; wherein the logic is configured to calculate ping loss rate, turn off and on the relay according to ping loss rate, and restart the ping watchdog.

2. The computer system of claim 1, wherein the software ping watchdog, the ping destination are configured with well-known Internet website IP addresses.

3. The computer system of claim 1, wherein the network controller is embedded in the micro controller.

4. The computer system of claim 1, further comprising one or more relays, with logic configured individually for each relay, wherein each logic comprises calculating ping loss rate to one or more computer servers, turn off and on the relay according to that ping loss rate, and restart pinging to the computer servers configured for this relay.

5. The computer system of claim 1, further comprising: an real time clock and an log software to record the relays on and off status along with the ping loss rate.

6. The computer system of claim 4, further comprising: LED for each relay to indicate the on and off status of the relay.

7. The computer system of claim 4, further comprising: LED for each relay to indicate the on and off status of the ping control for that relay; where in the logic is further configure to turn off the ping control for that relay if a preset number of relay on and off has been reached, and light up the no ping watch warning LED.

8. A method of operating power of a electronic device, the method comprising: checking for status of a software ping watchdog, turn off the power to the device if ping loss rate is greater than a predefined threshold value, wait a preset delay time, and turn on the power to that device.

9. The method of claim 8, further comprising: resetting the ping watchdog after power to the device is restored.

10. The method of claim 9, further comprising: turn off ping watchdog after a preset number of power reset within a preset time interval has been reached.
